(19) United States
(12) Patent Application Publication
(10) Pub. No.: US 2017/0365945 A1
(43) Pub. Date: Dec. 21, 2017

(54) EDGE ASSEMBLY FOR ATTACHING TO FLEXIBLE SUBSTRATES

(71) Applicant: OSRAM SYLVANIA Inc., Wilmington, MA (US)

(72) Inventors: Richard Speer, Concord, MA (US); Kenneth Grossman, Beverly, MA (US)

(73) Assignee: OSRAM SYLVANIA Inc., Wilmington, MA (US)

(21) Appl. No.: 15/533,314

(22) PCT Filed: Nov. 16, 2015
(86) PCT No.: PCT/US2015/060895

§ 371 Date: Jun. 5, 2017

Related U.S. Application Data
(60) Provisional application No. 62/087,089, filed on Dec. 3, 2014.

(51) Int. Cl. H01R 12/77; F21V 19/00; H01R 12/70; F21V 23/06; F21Y 2105/10; F21Y 2107/70

(52) U.S. Cl. CPC H01R 12/772; H01R 12/777; H01R 12/7011; F21V 23/06; F21V 19/003; F21Y 2107/70; F21Y 2105/10

(57) ABSTRACT

There is described an edge assembly for attaching to flexible substrates. An example assembly may comprise at least a first edge component and a compression retainer component. The first edge component may include at least one conductor to mate with one or more conductors on a surface of a flexible substrate after the first edge component is affixed to an edge of the flexible substrate by the compression retainer component. The edge assembly may also comprise a second edge component, wherein the flexible substrate may be compressed between the first and second edge components and held in place by the compression retainer component. The first edge component may further comprise an extension, including the at least one conductor, that may be used to convey power from a power source to the flexible substrate. The extension is accessible from outside the flexible substrate via a port in the compression retainer component.

### CROSS REFERENCES TO RELATED APPLICATIONS

This application claims the benefit of U.S. Provisional Application No. 62/087,089 filed Dec. 3, 2014, which is herein incorporated by reference.

### TECHNICAL FIELD

The present invention relates to electronic assemblies, and more specifically, to an assembly including at least an interface that may be attached to an edge of a flexible substrate.

### BACKGROUND

Electronics manufacturing typically uses circuit board materials such as, for example, polytetrafluoroethylene (Teflon), or composite materials like FR-4, FR-1, CEM-1 or CEM-3. At least one limitation in these materials is their rigidity. Rigidity is not a problem when devices are relatively large and flat. However, the miniaturization of devices, the advent of devices that have non-uniform shape including, for example, curved monitors, wearable devices, etc. has made this characteristic of traditional circuit board materials more of an issue. At least one solution to this problem may lie in flexible substrates. Flexible substrates employing, for example, polyethylene terephthalate (PET) may provide a surface to which electronic components may be mounted that may be bent, twisted, flexed, etc. without affecting the performance of the circuitry. Electronics may then be designed to accommodate applications not serviceable utilizing traditional materials.

While flexible substrates may grant design flexibility, flexible substrates must also be able to integrate with existing systems. Most systems will not use flexible substrates exclusively, and thus, must include a way to, for example, mount flexible substrates into traditional hardware, couple electronic circuitry on a flexible substrate to traditional circuitry, etc. Existing connector technologies including, for example, zero insertion force (ZIF) sockets may be problematic when used in conjunction with flexible substrates. For example, these types of connectors are attached to a substrate using certain connection points (e.g., via screwing, soldering, riveting, etc.). These connection points may form a strong attachment when a substrate is rigid. However, when used with a flexible substrate, the connection points may stress the pliable material to the point where a failure may occur in the functioning of the circuitry on the flexible substrate (e.g., due to extreme deformation of the flexible substrate.)

### BRIEF DESCRIPTION OF THE DRAWINGS

Reference should be made to the following detailed description which should be read in conjunction with the following figures, wherein like numerals represent like parts:

FIG. 1 illustrates an example edge assembly for attaching to flexible substrates consistent with the present disclosure;

FIG. 2 illustrates example first edge component configurations along with an example flexible substrate consistent with the present disclosure;

FIG. 3 illustrates a side view of an example edge assembly consistent with the present disclosure;

FIG. 4 illustrates an example lighting device utilizing a flexible substrate and an edge assembly attached to the flexible substrate consistent with the present disclosure consistent with the present disclosure;

FIGS. 5A and 5B illustrate an example port configured in a compression retainer component and an apparatus inserted into the example port consistent with the present disclosure;

FIG. 6 illustrates an example implementation of a lighting device consistent with the present disclosure;

FIG. 7 illustrates an example implementation of a socket capable of receiving an extension formed in the first edge component consistent with the present disclosure; and

FIG. 8 illustrates example operations for attaching an edge assembly to a flexible substrate consistent with the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to an edge assembly for attaching to flexible substrates. In general, an assembly may couple to an edge of a flexible substrate to retain the substrate and, in at least one embodiment, may also electronically couple the flexible substrate to a power source. An example assembly may comprise at least a first edge component and a compression retainer component. An example first edge component may include at least one conductor to mate with conductors on a surface of a flexible substrate after the first edge component is affixed to an edge of the flexible substrate by the compression retainer component. The at least one conductor may convey power to at least one device (e.g., light emitting diode (LED)) mounted on the flexible substrate. The edge assembly may also comprise a second edge component, wherein the flexible substrate may be compressed between the first and second edge components and held in place by compressive force provided by the compression retainer component. The first/second edge components may be more rigid than the flexible substrate. The first edge component may further comprise an extension to which is routed an end of the at least one first edge component conductor. The extension may be accessible from outside of the edge assembly via a port in the compression retainer component. For example, the port may accept an apparatus (e.g., a power cable) for providing power to the flexible substrate via the extension. Alternatively, the port may allow the extension to be plugged into an external socket for delivering power to the flexible substrate. At least one benefit that may be realized by the edge assembly is that the flexible substrate may be held securely without being damaged while power is also conveyed to the flexible substrate.

In at least one embodiment, an assembly for coupling to a flexible substrate may comprise, for example, at least a first edge component and a compression retainer component. The first edge component may be to couple to a first surface of a flexible substrate. The first edge component may include at least one conductor to mate with at least one conductor on the first surface of the flexible substrate. The compression retainer component may affix at least the first edge component to the flexible substrate.

In at least one embodiment, the assembly may comprise a second edge component to couple to a second surface of the flexible substrate opposite of the first surface. The first edge component and the second edge component may be, for example, more rigid than the flexible substrate. The compression retainer component may then affix the first and second edge components to the flexible substrate by compressing the flexible substrate between the first and second edge components using a clipping action. The first surface may comprise at least one light emitting diode (LED) coupled to the at least one first surface conductor, the at least one first surface conductor causing the at least one LED to emit light by conveying power to the at least one LED. For example, the first surface may comprise a plurality of conductors and the first edge component may comprise a separate conductor to mate with each of the plurality of first surface conductors. Alternatively, the first surface may comprise a plurality of conductors and the first edge component comprises one conductor to mate with the plurality of first surface conductors concurrently.

In at least one embodiment, the first edge component may also comprise an extension to which an end of the at least one first edge component conductor is routed. The compression retainer component may comprise a port to accept the extension when the compression retainer component is affixing the first edge component to the flexible substrate. For example, the port may be configured to receive an apparatus to provide power to the flexible substrate via the extension. Alternatively, the assembly may further comprise a socket to receive the extension and to convey power to the flexible substrate via the extension. An example lighting device consistent with the present disclosure may comprise, for example, at least one flexible substrate, a power source and an assembly. The at least one flexible substrate may comprise at least one light emitting component. The assembly may retain at least an edge of the at least one flexible substrate to the cause the at least one light emitting component to emit light by conveying power from the power source to the at least one flexible substrate. The assembly may include, for example, at least a first edge component and a compression retainer component. The first edge component may couple to a first surface of the flexible substrate, the first edge component including at least one conductor to mate with at least one conductor on the first surface of the flexible substrate. The compression retainer component may affix at least the first edge component to the flexible substrate, the compressing retainer component including a port allowing power to be received from the power source. An example for affixing an assembly to a flexible substrate consistent with the present disclosure may comprise applying a first edge component including at least one conductor to a surface of a flexible substrate including at least one conductor in a manner that allows the at least one first edge component conductor to be coupled to the at least one flexible substrate conductor, and affixing the first edge component to the flexible substrate with a compression retention component.

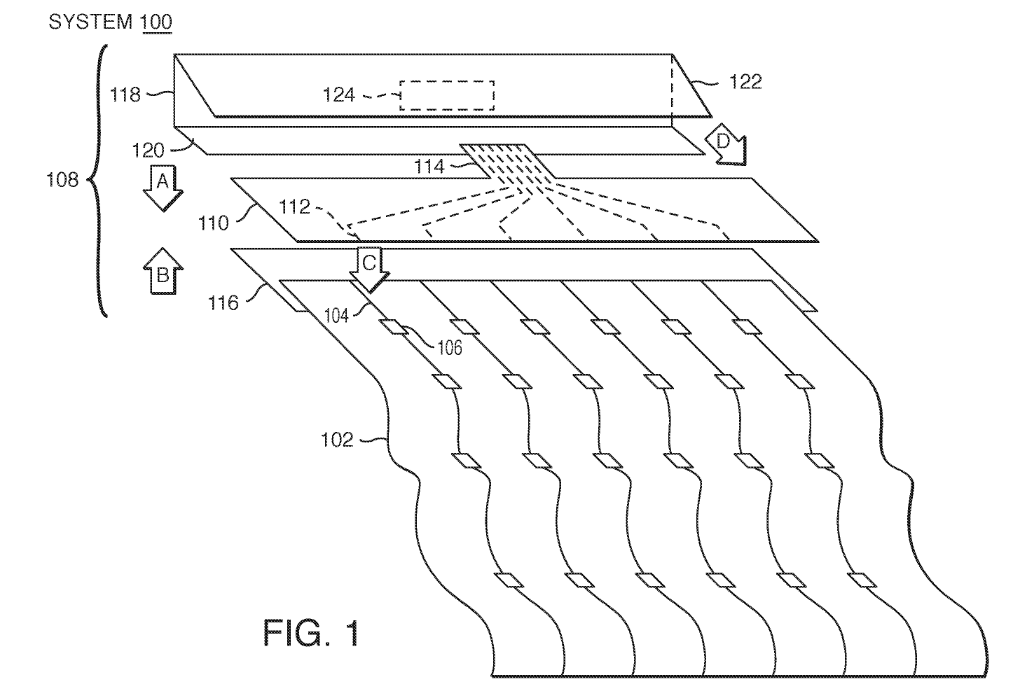

FIG. 1 illustrates an example edge assembly for attaching to flexible substrates consistent with the present disclosure. Initially, it is important to note that while FIG. 1 discloses an example configuration for system 100 comprising particular components arranged, coupled, oriented, etc. in a particular manner, the example configuration of FIG. 1 is presented herein merely for the sake of explanation. Rearrangement, insertion, removal, replacement, etc. of the components in system 100 is permissible consistent with the teachings of the present disclosure.

System 100 may comprise flexible substrate 102 to which edge assembly 108 may be attached. Flexible substrate 102 may include at least conductors 104 and components 106. For example, conductors 104 may be circuit traces based on a conductive material that is woven into flexible substrate 102, embedded within flexible substrate 102, bonded to flexible substrate 102, sprayed/printed on flexible substrate 102 (e.g., using conductive ink), etc. For example, in at least one implementation conductors 104 may comprise copper strips or ribbons that are fully exposed (e.g., coupled to a surface of flexible substrate 102) or at least partially exposed (e.g., enclosed, at least in part, within flexible substrate 102) to a degree that allows selective coupling with other parts of system 100 such as other conductors, components, etc. Conductors 104 may also be extended beyond the edges of flexible substrate 102 to better facilitate external coupling. Components 106 may then be coupled to conductors 104 via solder, adhesive, a mechanical binding, etc. in manner that may allow power to be conveyed to components 106 via conductors 104. The arrangement of conductors 104 and/or components 106 disclosed in FIG. 1 is merely an example useful to explain various embodiments consistent with the present disclosure, and may vary depending on the particular application to which the teachings described herein may be applied. For example, the implementation disclosed in FIG. 1 may be suitable for LED-based lighting. Components 106 may be LEDs arranged at certain locations along conductors 104 that may operate individually or in unison to generate a desired light output (e.g., from a fixture into which one or more flexible substrates 102 are embedded).

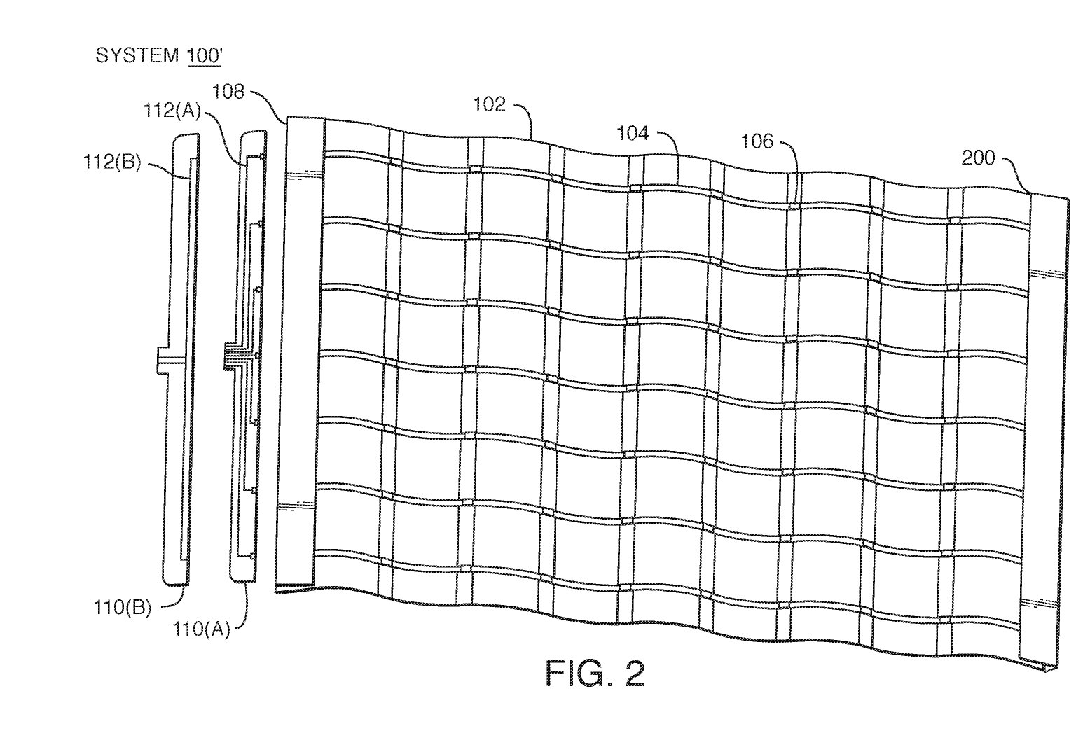

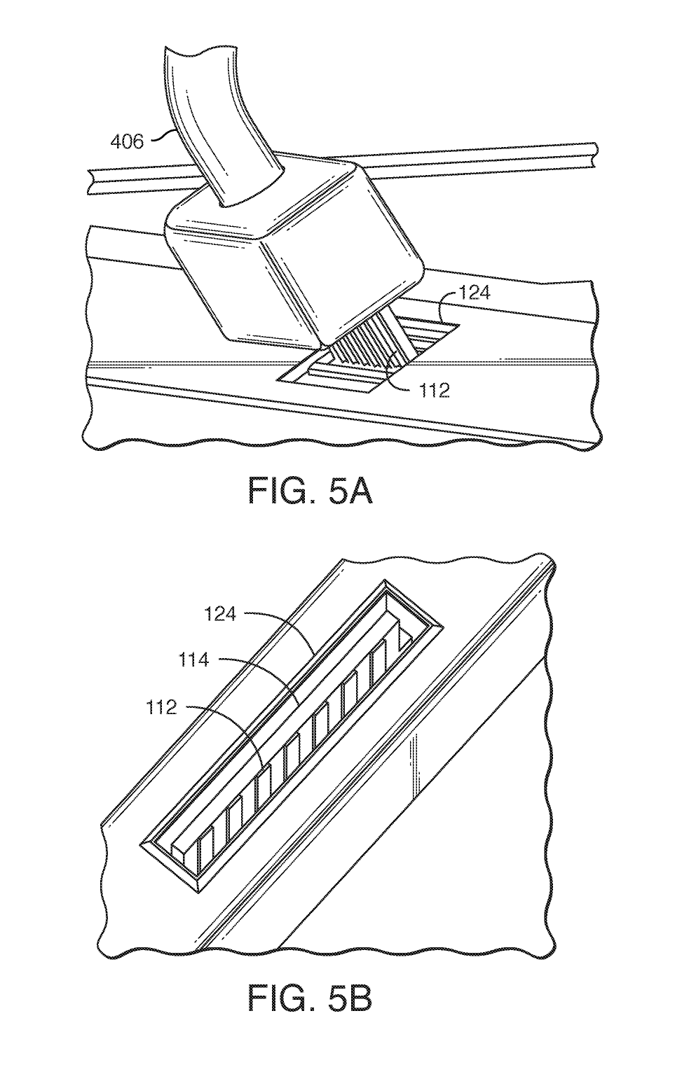

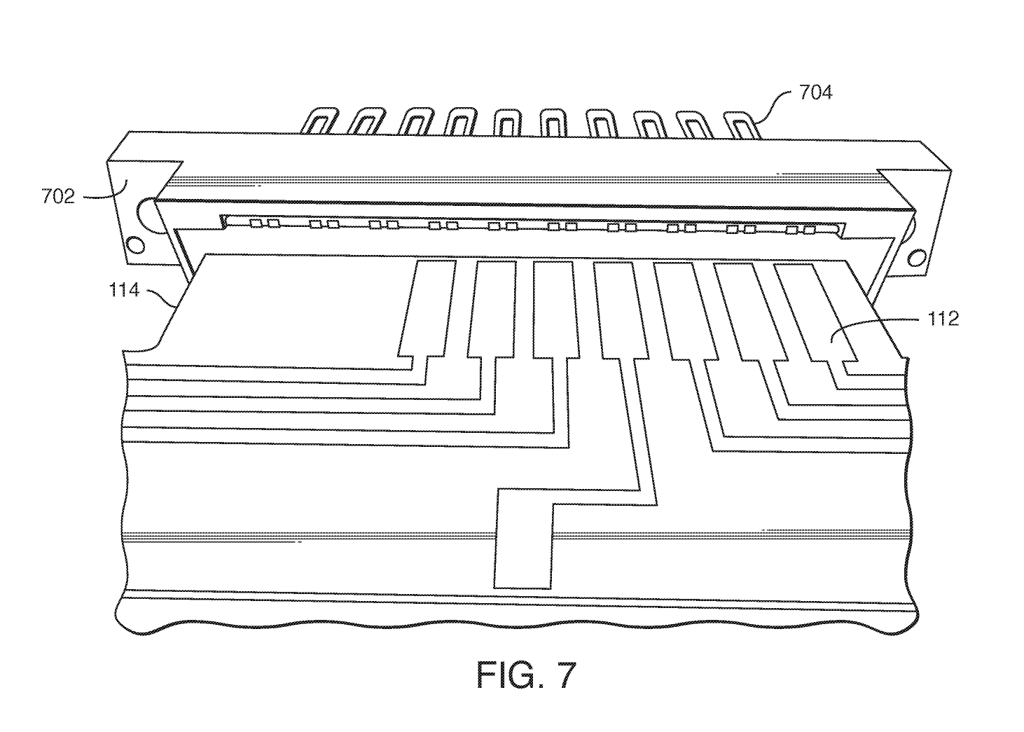

Edge assembly 108 may comprise, for example, at least first edge component 110 and compression retention component 118. In at least one embodiment, edge assembly 108 may also include second edge component 116. First edge component 110 and/or second edge component 116 may be constructed using a material that is more rigid that flexible substrate 102 such as, for example, traditional circuit board material, plastic, metal, etc. The use of a more rigid material may allow edge assembly 108 to both retain and protect the edge of flexible substrate 102. First edge component 110 may comprise at least one conductor 112. Conductor 112 is shown in FIG. 1 as a plurality of individual conductors. Dotted lines have been used to indicate that conductor 112 is exposed on the non-visible (bottom) side of first edge component 110 (e.g., the side that will make contact with the surface of flexible substrate 102). The number of conductors 112 in first edge connector 110 may vary depending on how power is to be provided to conductors 104 in flexible substrate 102. Different power schemes will be discussed in regard to FIG. 2. First edge component 110 may further comprise extension 114 to which ends of conductors 112 are routed. Extension 114 may constitute part of an interface through which power may be provided to flexible substrate 102. Example interfaces will be described further in regard to FIGS. 5 and 7.

Compression retention component 118 may comprise, for example, at least extended members 120 and 122 that may generate compressive force to affix at least first edge component 110 to flexible substrate 102 using a “clipping” action (e.g., similar to how a binder clip may hold a group of papers together). Compression retention component 124 may be constructed of materials including, but not limited to, plastic, metal, wood, etc. such that extended members 120 and 122 may flex in manner allowing compression to be generated inwardly (e.g., towards each other). Compression retention component 118 may also comprise port 124 to accept extension 114 upon introduction of compression retention component 118 into edge assembly 108. Port 124 may simply be a hole formed in the back of compression retention component 118 to allow external access to extension 114. However, port 124 may further comprise mechanical retention and/or electrical components to accept an apparatus (e.g., a power cable) for conveying power to flexible substrate 102. Different configurations for port 124 will be discussed in regard to at least FIGS. 5 and 7. In an example of operation employing both first edge connector 110 and second edge connector 116, the edge of flexible substrate 102 may be positioned between first edge connector 110 and second edge connector 116, as shown by the arrows labeled “A” and “B” in FIG. 1, so that conductors 112 in first edge component 110 are mated to conductors 104 as illustrated by the arrow labeled “C” in FIG. 1. Compression retention component 118 may then be applied to the combined first edge component 110, flexible substrate 102 and second edge component 116, as shown by the arrow labeled “D” in FIG. 1, so that extended members 120 and 122 compress flexible substrate 102 between first edge component 110 and second edge component 116. During the application of compression retention component 118, extension 114 may be received into port 124 so that extension 114 may be readily accessible from outside edge assembly 108 (e.g., so that a power source may be provide power to flexible substrate 102 via extension 114). While only one edge assembly 108 is shown in FIG. 1, edge assemblies may be attached to any or all of the edges of flexible substrate 102. These further edge assemblies may or may not comprise any electronics (e.g., conductors 112) as they may serve a strictly structural purpose (e.g., to allow flexible substrate 102 to be formed into a certain shape or positioned in a particular orientation, to provide protection for the edges of flexible substrate 102, etc.).

FIG. 2 illustrates example first edge component configurations along with an example flexible substrate consistent with the present disclosure. FIG. 2 discloses an example system 100′ comprising at least flexible substrate 102, edge assembly 108 and other edge assembly 200. As discussed above, other edge assembly 200 may comprise electronics (e.g., to link system 100′ to another system) or may simply be a structural add-on to provide support to flexible substrate 102. Along with system 100′, two example first edge components 110(A) and 110(B) are also illustrated. Similar to FIG. 1, first edge component 110(A) comprises a plurality of conductors 112(A), wherein each conductor 112(A) corresponds to a conductor 104 in flexible substrate 102. The configuration of conductors 112(A) may allow for a controlled application of power to components 106 on a conductor-by-conductor basis. Given the example wherein system 100′ is being employed in a lighting device, performing conductor-by-conductor power control may allow for the generation of different intensities of light, different colors of light, etc. depending on how the LEDs on each conductor 104 are controlled. Alternatively, first edge component 110(B) may comprise a single conductor 112(B). Conductor 112(B) may provide power to all of conductors 104 concurrently, and thus, all components 106 may operate in a similar manner. Again referring to the lighting example, the configuration of first edge connector 110(B) may provide a way to generate substantially uniform light output from all LEDs, which may provide less control but may result in system 100′ being much simpler to implement, cost effective, etc. Further to the examples disclosed in FIGS. 1 and 2, other configurations are possible consistent with the present disclosure. For example, a plurality of conductors 112 having a total number less than the number of conductors 104 may be possible. Conductors 104 may then be “grouped” so that each conductor 112 services a group of conductors 104. For example, two (2) conductors 112 may service all of conductors 104 with conductors 104 being divided into two groups on an alternating basis (e.g., every other conductor 104 is in the same group). This may allow for some flexibility in control without the level of complexity in a conductor-by-conductor solution.

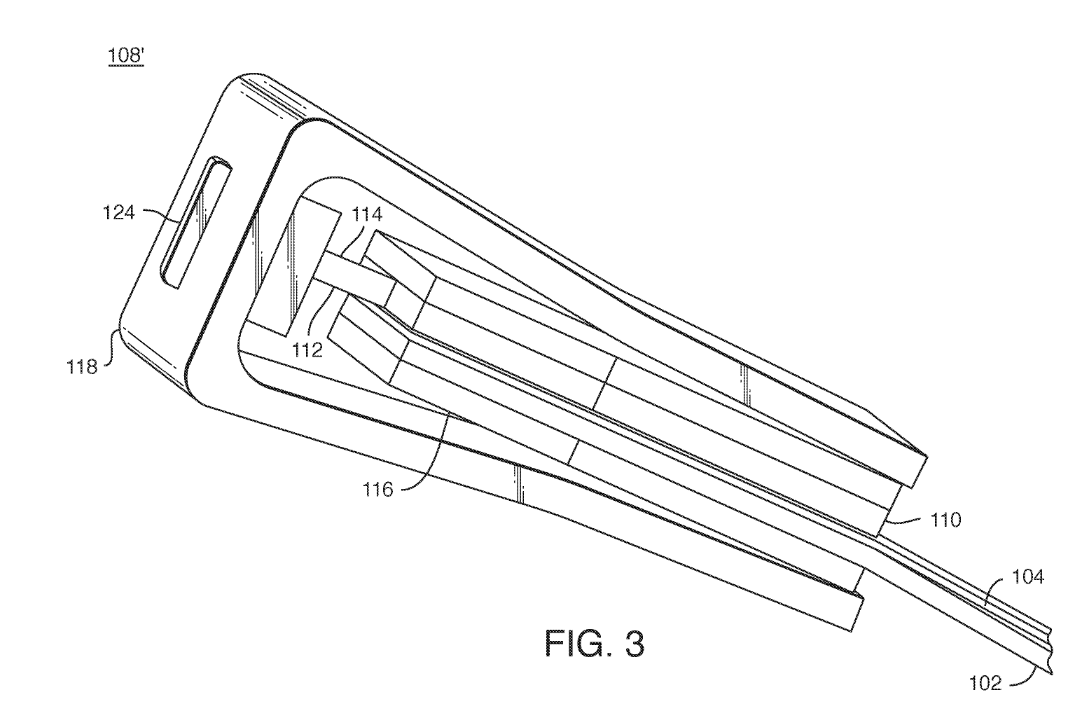

FIG. 3 illustrates a side view of an example edge assembly consistent with the present disclosure. FIG. 3 discloses edge assembly 108′ coupled to flexible substrate 102 comprising at least conductors 104. Flexible substrate 102 may be sandwiched between first edge component 110 and second edge component 116. While not visible in FIG. 3, at least one conductor 112 may mate with conductors 104 within the area where first edge component 110 comes into contact with the surface of flexible substrate 102. The other end of conductor 112 may reside on extension 114 (e.g., to allow power to be provided to flexible substrate 102 via extension 114). Flexible substrate 102 may be retained between first edge component 110 and second edge component 116 by compression retention component 118, which may comprise port 124 to provide a way for extension 114 to be accessed from outside of edge assembly 108′.

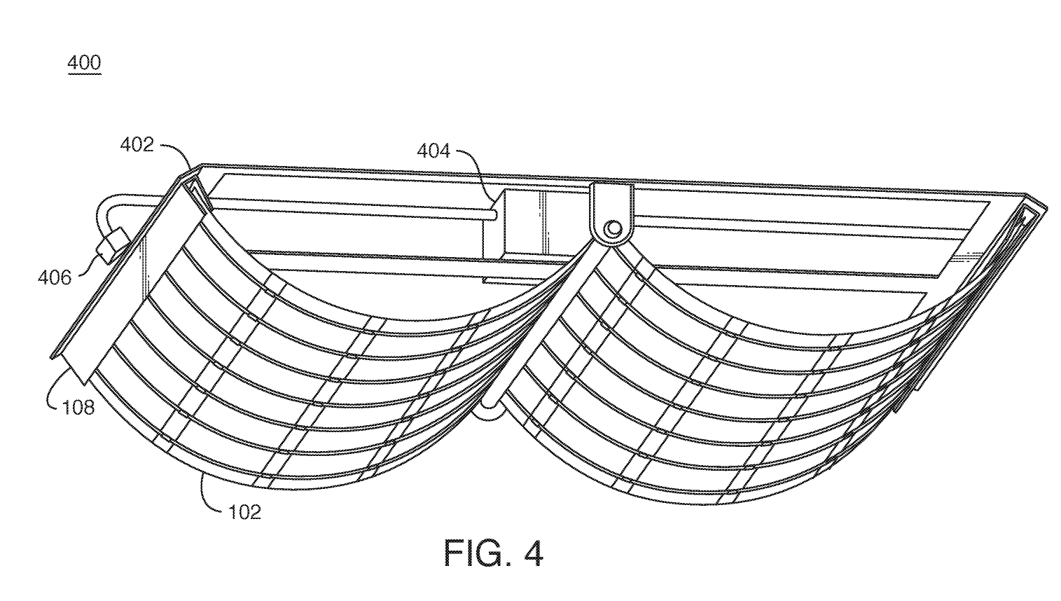

FIG. 4 illustrates an example lighting device utilizing a flexible substrate and an edge assembly attached to the flexible substrate consistent with the present disclosure. Lighting device 400 may comprise, for example, at least equipment 402 to which may be mounted at least power source 404. Power source 404 may include circuitry to generate power from an internal source (e.g., a battery) or an external source (e.g., a power grid, a generator, etc.), and may further employ an apparatus 406 (e.g., a connector) to couple to edge assembly 108 for delivering power to flexible substrate 102. The example disclosed in FIG. 4 shows a lighting application, however embodiments consistent with the present disclosure are not specifically limited to only this usage. Any system that needs to power components 106 mounted on flexible substrate 102 may employ the various teachings that are described herein.

In lighting device 400, flexible substrate 102 may be coupled to, and supported by, equipment 402 for the purpose of generating light. For example, flexible substrate 102 may be held or draped in a certain orientation so that light is emitted in a certain direction, with a certain intensity, etc. In one example implementation, lighting device 400 may be a ceiling mounted light fixture. Power supply 404 may generate power that may be provided to flexible substrate 102 via apparatus 406. Apparatus 406 may plug into edge assembly 108, which may convey the power to flexible substrate 102. As discussed in regard to FIGS. 1 and 2, the power may be conveyed via extension 114 to flexible substrate 102. The number of conductors 112 in first edge component 110 may dictate the amount of control over light output intensity, color, etc.

FIGS. 5A and 5B illustrate an example port configured in a compression retainer component and an apparatus inserted into the example port consistent with the present disclosure. As shown in FIG. 5A, apparatus 406 (e.g., a power cable connector) may insert into port 124 to, for example, convey power to flexible substrate 102. As shown in FIG. 5B, port 124 may enclose extension 114 in a manner that will guide an inserted apparatus 406 into a certain orientation allowing contact between a portion of apparatus 406 and extension 114. In at least one embodiment, the certain orientation may allow conductors exposed on the portion of apparatus 406 that comes into contact with extension 114 to mate with the ends of conductors 112 (e.g., dark bands) situated on extension 114. In this manner, the amount of power delivered to each conductor 112 may be controlled (e.g., given that first edge component 110 comprises a plurality of conductors 112). While not depicted in FIG. 5, consistent with the present disclosure first edge assembly 110 may comprise conductors 112 on both sides. As a result, extension 114 may have ends of conductors 112 on both sides, and apparatus 406 may be altered to mate with the ends of conductors 112 exposed on both sides of extension 114. This configuration may be useful in a variety of implementations including, but not limited to, powering a single flexible substrate 102 wherein conductors 104 are coupled to both the top-side and bottom-side conductors 112 in edge assembly 108 (e.g., in a series circuit configuration), for powering two different flexible substrates 102 (e.g., back-to-back.) It is important to note that while a specific example of apparatus 406 coupling with port 124 has been illustrated in FIG. 5, that alternative configurations are possible consistent with the present disclosure. At least one alternative configuration is presented in FIG. 7. It may also be possible for a plurality of ports 124 to be formed into compression retention component 118 so that more than one apparatus 406 may be coupled to the same edge assembly 108. In addition to receiving power for flexible substrate 102, such a configuration may allow for implementations wherein, for example, more than one system 100 may be coupled together to support larger applications.

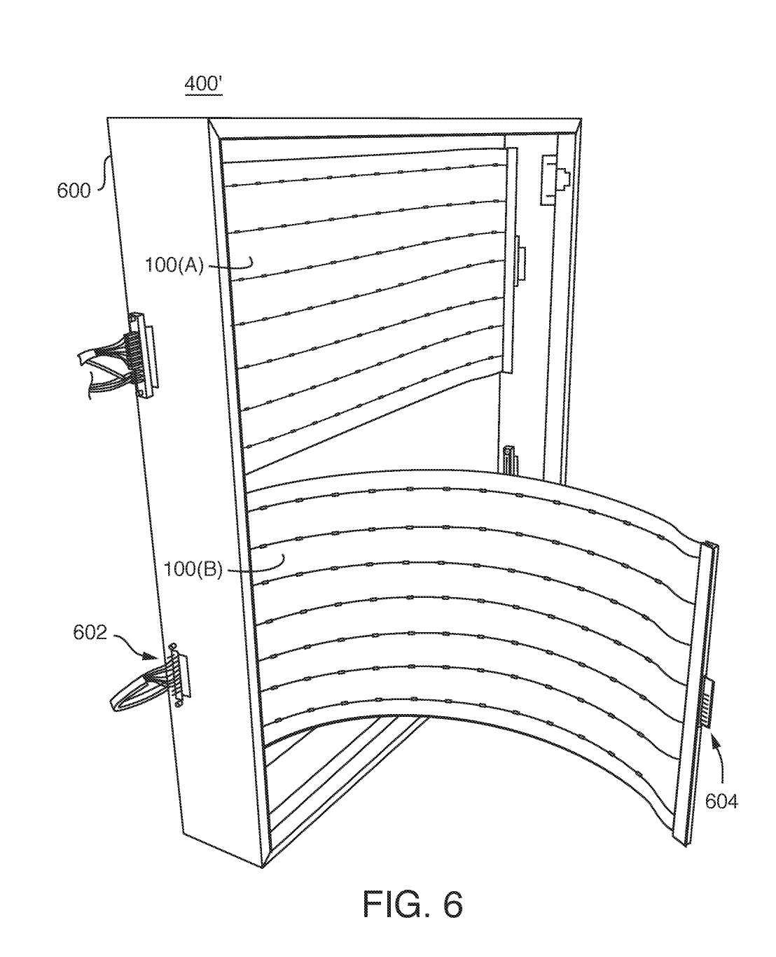

FIG. 6 illustrates an example implementation of a lighting device consistent with the present disclosure. Example lighting device 400′ comprises two systems 100(A) and 100(B) (e.g., flexible substrates 102 including edge assemblies 108) mounted within housing 600. In the example implementation of systems 100(A) and (B), flexible substrate 102 may be constructed by laminating conductors 104 between two sheets of PET. Openings may be formed in at least one of the two PET sheets to facilitate coupling components 106 (e.g., LEDs) to conductors 104. In this manner, conductors may avoid contact with other conductive components (e.g., from becoming grounded by contacting housing 600), may be protected from damage, corrosion, etc. As mentioned previously, this example depicts at 602 and 604 how each system 100(A) and (B) may include more than one edge assembly 108. Including more than one edge assembly 108 in systems 100(A) and (B) may allow for functionality in lighting device 400′ including, but not limited to, the ability to use various components 106 for supporting different types of lighting applications, the ability to couple lighting devices 400′ together for larger applications, etc.

FIG. 7 illustrates an example implementation of a socket capable of receiving an extension formed in the first edge component consistent with the present disclosure. Photograph 700 depicts a socket or connector 702 into which extension 114 may be inserted. For example, Socket 702 may comprise at least one conductor 704 that may mate with the end of at least one conductor 112 exposed on extension 114. In at least one example implementation, socket 702 may be mounted in housing 600 as depicted in FIG. 6. Socket 702, or more specifically the at least one conductor 704 in socket 702, may then be coupled to, for example, a power source or to another system 100 in a chain configuration.

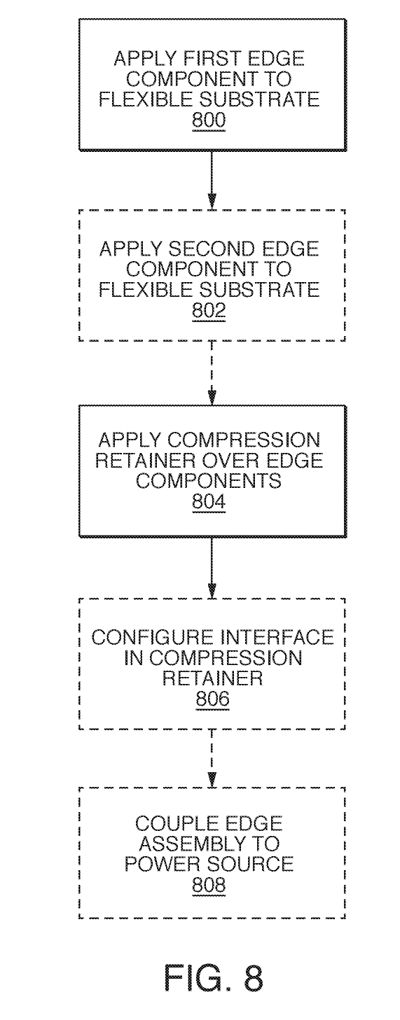

FIG. 8 illustrates example operations for attaching an edge assembly to a flexible substrate consistent with the present disclosure. In operation 800, first edge component 110 may be applied to an edge of flexible substrate 102. For example, first edge component 110 may be applied to flexible substrate 102 so that at least one conductor 112 in first edge component 110 may mate with conductors 104 in flexible substrate 102. Operation 802 may be optional based on whether second edge component 116 is being utilized in edge assembly 108. In operation 802, second edge component 116 may be applied to flexible substrate 102 on a surface that is opposite of the surface to which first edge component 110 was applied in operation 800. Compression retainer component 118 may then be applied over first edge component 110 and second edge component 116 in operation 804 so that flexible substrate 102 may be retained between the edge components. Operation 806 may be optional in that there may be no need to configure interface 114 in compression retainer component 118 (e.g., if port 124 is simply an opening formed in compression retainer component 118). However, given a situation wherein port 124 is a more complex construct (e.g., a socket to receive apparatus 406, a connector, etc.), then in operation 806 some configuration may be required. Operation 808 may also be optional depending on what level of manufacture is being performed. For example, in operation 808 the edge assembly may be coupled to a power source. However, this coupling may be necessary only in certain situations (e.g., wherein system 100 is being installed into a lighting device 400).

While FIG. 8 illustrates various operations according to an embodiment, it is to be understood that not all of the operations depicted in FIG. 8 are necessary for other embodiments. Indeed, it is fully contemplated herein that in other embodiments of the present disclosure, the operations depicted in FIG. 8, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection.

Thus, this disclosure is directed to an edge assembly for attaching to flexible substrates. An example assembly may comprise at least a first edge component and a compression retainer component. An example first edge component may include at least one conductor to mate with conductors on a surface of a flexible substrate after the first edge component is affixed to an edge of the flexible substrate by the compression retainer component. The edge assembly may also comprise a second edge component, wherein the flexible substrate may be compressed between the first and second edge components and held in place by the compression retainer component. The first edge component may further comprise an extension, including the at least one conductor, that may be used to convey power from a power source to the flexible substrate. The extension is accessible from outside the flexible substrate via a port in the compression retainer component.

According to one aspect there is provided an assembly for coupling to a flexible substrate. The assembly may comprise a first edge component to couple to a first surface of a flexible substrate, the first edge component including at least one conductor to mate with at least one conductor on the first surface of the flexible substrate and a compression retainer component to affix at least the first edge component to the flexible substrate.

According to another aspect there is provided a lighting device. The lighting device may comprise at least one flexible substrate comprising at least one light emitting component, a power source and an assembly to retain at least an edge of the at least one flexible substrate and to the cause the at least one light emitting component to emit light by conveying power from the power source to the at least one flexible substrate, the assembly including a first edge component to couple to a first surface of the flexible substrate, the first edge component including at least one conductor to mate with at least one conductor on the first surface of the flexible substrate and a compression retainer component to affix at least the first edge component to the flexible substrate, the compressing retainer component including a port allowing power to be received from the power source.

According to another aspect there is provided a method for affixing an assembly to a flexible substrate. The method may comprise applying a first edge component including at least one conductor to a surface of a flexible substrate including at least one conductor in a manner that allows the at least one first edge component conductor to be coupled to the at least one flexible substrate conductor and affixing the first edge component to the flexible substrate with a compression retention component.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An assembly for coupling to a flexible substrate, comprising:
a first edge component to couple to a first surface of a flexible substrate, the first edge component including at least one conductor to mate with at least one conductor on the first surface of the flexible substrate; and
a compression retainer component to affix at least the first edge component to the flexible substrate.

2. The assembly according to claim 1, further comprising a second edge component to couple to a second surface of the flexible substrate opposite of the first surface.

3. The assembly according to claim 2, wherein the first edge component and the second edge component are more rigid than the flexible substrate.

4. The assembly according to claim 2, wherein the compression retainer component affixes the first and second edge components to the flexible substrate by compressing the flexible substrate between the first and second edge components.

5. The assembly according to claim 1, wherein the first surface comprises at least one light emitting diode (LED) coupled to the at least one first surface conductor, the at least one first surface conductor being to cause the at least one LED to emit light by conveying power to the at least one LED.

6. The assembly according to claim 1, wherein the first surface comprises a plurality of conductors and the first edge component comprises a plurality of separate conductors that each mate with a respective one the plurality of first surface conductors.

7. The assembly according to claim 1, wherein the first surface comprises a plurality of conductors and the first edge component comprises a single conductor that mates with the plurality of first surface conductors concurrently.

8. The assembly according to claim 1, wherein the first edge component further comprises an extension to which an end of the at least one first edge component conductor is routed.

9. The assembly according to claim 8, wherein the compression retainer component comprises a port to accept the extension.

10. The assembly according to claim 9, wherein the port is configured to receive an apparatus to provide power to the flexible substrate via the extension.

11. The assembly according to claim 8, further comprising a socket to receive the extension and to convey power to the flexible substrate via the extension.

12. A lighting device, comprising:
at least one flexible substrate comprising at least one light emitting component;
a power source; and
an assembly to retain at least an edge of the at least one flexible substrate and cause the at least one light emitting component to emit light by conveying power from the power source to the at least one flexible substrate, the assembly including:
a first edge component to couple to a first surface of the flexible substrate, the first edge component including at least one conductor to mate with at least one conductor on the first surface of the flexible substrate; and
a compression retainer component to affix at least the first edge component to the flexible substrate, the compressing retainer component including a port allowing power to be received from the power source.

13. The device according to claim 12, wherein the first edge component further comprises an extension to which an end of the at least one first edge component conductor is routed, the port allowing the extension to be accessed from outside of the assembly.

14. The device according to claim 13, further comprising an apparatus to couple the power source to the assembly via the extension, the apparatus including a connector that plugs into the port to mate with the end of the at least one first edge component conductor.

15. The device according to claim 13, further comprising an apparatus to couple the power source to the assembly via the extension, the apparatus including a socket into which the extension is inserted to allow mating with the end of the at least one first edge component conductor.

16. The device according to claim 12, further comprising equipment to which at least the flexible substrate is affixed, the equipment holding the flexible substrate in a particular position so as to direct light emitted from the at least one light emitting component.

17. A method for affixing an assembly to a flexible substrate, comprising:
applying a first edge component including at least one conductor to a surface of a flexible substrate including at least one conductor in a manner that allows the at least one first edge component conductor to be coupled to the at least one flexible substrate conductor; and
affixing the first edge component to the flexible substrate with a compression retention component.

18. The method according to claim 17, further comprising:
prior to affixing the compression retention component, applying a second edge component to a second surface of the flexible substrate opposing the first surface to which the first edge component is to coupled; and
affixing the first and second edge components to the flexible substrate with a compression retention component.

19. The method according to claim 17, further comprising:
configuring a port in the compression retention component to receive an extension in the first edge component when the compression retention component is affixed, the extension comprising an end of the at least one first edge component conductor.

20. The method according to claim 19, further comprising:
coupling the extension to a power source via the port.
